(19) United States
(12) Patent Application Publication
(10) Pub. No.: US 2013/0164558 A1
(43) Pub. Date: Jun. 27, 2013

(54) Oxidation Resistant Coating with Substrate Compatibility

(71) Applicants: Benjamin Joseph Zimmerman, Enfield, CT (US); Michael J. Maloney, Marlborough, CT (US)

(72) Inventors: Benjamin Joseph Zimmerman, Enfield, CT (US); Michael J. Maloney, Marlborough, CT (US)

(73) Assignee: UNITED TECHNOLOGIES CORPORATION, Hartford, CT (US)

(21) Appl. No.: 13/337,542

(22) Filed: Dec. 27, 2011

(51) Int. Cl. B32B 15/01; B05D 5/00; C22C 19/05

(52) U.S. Cl. 428/678; 420/443

(57) ABSTRACT

An oxidation resistant coating has a composition which comprises from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

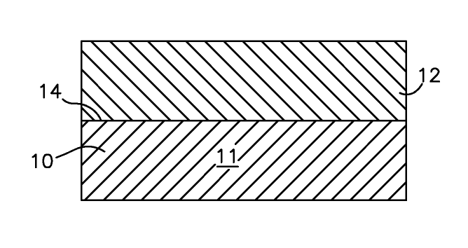

### BACKGROUND

This disclosure relates to the field of protective coatings for use on metallic parts which are used at elevated temperatures and have particular utility in the field of gas turbine engines.

Current metallic coatings on hot section turbine engine components provide oxidation and corrosion protection and act as bond coats for ceramic thermal barrier coatings on parts or components used in gas turbine engines. Both MCrAlY and aluminide coatings were developed to ensure acceptable performance on then-current base alloys used for part or component substrates. More recent single crystal substrate alloys, while providing improved mechanical properties, exhibit oxidation debits and detrimental reaction zones with current bond coats.

It is important for the turbine engine components to have a coating which is compatible with the substrate material.

### SUMMARY

In accordance with the present disclosure, there is provided a coating which is compatible with nickel- and cobalt-based superalloys.

In accordance with the present disclosure, there is provided a coating which comprises from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

Further, in accordance with the present disclosure, there is provided a part, such as a turbine engine component, having a substrate and a coating applied to the substrate, which coating comprises from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

Other details of the oxidation resistant coating having substrate compatibility are set forth in the following drawings and detailed description in which like reference numerals depict like elements.

### BRIEF DESCRIPTION OF THE DRAWING(S)

The Figure illustrates a part having a coating applied thereto.

### DETAILED DESCRIPTION OF THE PREFERRED EMBODIMENT(S)

Referring now to the drawings, a part 10, such as a turbine engine component, having a substrate 11 to which is applied a coating 12 which imparts oxidation resistance to the part and which is compatible with the material forming the part. If desired, the coating 12 may be applied directly to a surface 14 of the substrate.

The substrate 11 may be formed from a wide range of metallic materials including, but not limited to, nickel-based and cobalt-based superalloys. For example, the substrate 11 may be a single crystal nickel-based superalloy.

The coating 12 comprises from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel. As can be seen from the above composition, there is a reduced aluminum content which provides a reduction in the formation of SRZ in alloys that are prone to it. More aluminum in the coating 12 may create reaction zone problems, while less aluminum does not provide enough aluminum to maintain a good protective scale. Less reactive elements (Y, Hf, Si, and Zr) may increase oxidation kinetics, while more reactive elements may lead to short-circuit oxidation. More chromium may reduce the dominant phase, gamma prime and less chromium may hurt hot corrosion resistance. A highly desirable composition for the coating 12 lies right in the middle of the above ranges.

The coating 12 may be applied using either plasma spray or physical vapor deposition techniques to the substrate 11 from which the part 10 is formed. For example, the coating may be applied using cathodic arc deposition.

The coating 12 has particular utility as a bond coat. In such a situation, the coating 12 would be applied directly onto at least one surface 14 of the substrate 11. A thermal barrier coating (not shown) may be applied over the coating 12.

The coating described herein shows much less formation of a secondary reaction zone than with traditional MCrAlYs or with aluminide or platinum-aluminide coatings, particularly when used on higher generation single crystal alloys which may suffer from microstructural instability. The elements which make these superalloys strong and creep resistant can make them prone to instability, especially in the vicinity of a coating. Aluminum diffusion from the coating is known to exacerbate this problem. This is because aluminum from the coating may combine with the alloy and form a layer known as the secondary reaction zone. This layer has poor mechanical properties and is associated with topologically close-packed (TCP) features which can encourage cracking and transition to a gamma prime matrix (rather than a gamma matrix in the rest of the alloy). As noted above, there is less formation of SRZ with the coatings described herein.

A coating having the composition described herein exhibits corrosion resistance, high temperature oxidation resistance, and mechanical properties similar to MCrAlY coatings. The EB-PVD thermal barrier coating spallation resistance for this coating is 8× that of the baseline coating. A part having an oxidation resistant coating having a composition in accordance with the present disclosure and a thermal barrier coating was subjected to burner rig testing and 2050° F. It was found that the coating had an average thermal barrier coating spallation which was 864% of a composition coating formed from a traditional NiCoCrAlY material with higher cobalt and chromium levels. Burner rig testing showed the coating described herein had an oxidation resistance which was 92% of the comparison coating (burner rig @ 2150° F.), a hot corrosion resistance which was 130% of the comparison coating (burner rig @ 1600° F.) and high cycle fatigue and thermo-mechanical fatigue equivalent to the comparison coating.

There has been provided herein an oxidation resistant coating with substrate compatibility. While the coating has been described in the context of particular embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. An oxidation resistant coating for use on a turbine engine component comprising from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

2. A part comprising a substrate and a coating deposited on a surface of said substrate, said coating comprising from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

3. The part according to claim 2, wherein said substrate comprises a nickel-based superalloy.

4. The part according to claim 2, wherein said substrate comprise a cobalt-based superalloy.

5. The part according to claim 2, wherein said coating is applied directly to a surface of said substrate.

6. The part according to claim 2, wherein said part is a turbine engine component.

7. A process for forming an oxidation resistant coating on a part, said process comprising the steps of:
providing a part having a substrate;
forming a coating on a surface of said substrate; and
said coating forming step comprising forming a coating comprising from 11 to 14 wt % chromium, from 11 to 14 wt % cobalt, from 7.5 to 9.5 wt % aluminum, from 0.20 to 0.60 wt % yttrium, from 0.10 to 0.50 wt % hafnium, from 0.10 to 0.30 wt % silicon, from 0.10 to 0.20 wt % zirconium, and the balance nickel.

8. The process according to claim 7, wherein said part providing step comprises providing a part having a substrate formed from one of a nickel-based superalloy and a cobalt-based superalloy.
